(19) United States
(12) Patent Application Publication
(10) Pub. No.: US 2019/0072934 A1
(43) Pub. Date: Mar. 7, 2019

(54) PARAMETRIC PORTRAITURE DESIGN AND CUSTOMIZATION SYSTEM

(71) Applicant: Debbie Eunice Stevens-Wright, North Andover, MA (US)

(72) Inventor: Debbie Eunice Stevens-Wright, North Andover, MA (US)

(21) Appl. No.: 16/119,390

(22) Filed: Aug. 31, 2018

Related U.S. Application Data
(60) Provisional application No. 62/553,379, filed on Sep. 1, 2017.

(51) Int. Cl. G05B 19/4099

(52) U.S. Cl. CPC G05B 19/4099; G05B 2219/49023

(57) ABSTRACT

An interactive online platform for the personalization, purchase, and delivery of personalized creative sculptures and designs is provided. The parametric portraiture design and customization system combines CAD solutions, WebGL technology, and 3D artist software to produce creative sculptures and an interactive space for the personalization of these creative portraiture sculptures and designs. The individual resemblance for the creative designs is developed through upload of scans or photos. The resemblance is then embedded into sculpture designs that can be personalized to capture valued experiences.

### CROSS-REFERENCE TO RELATED APPLICATION

This application claims the benefit of priority of U.S. provisional application No. 62/553,379, filed 1 Sep. 2017, the contents of which are herein incorporated by reference.

### BACKGROUND OF THE INVENTION

The present invention relates to portraiture services, and more particularly to a parametric portraiture design and customization system.

Cell phone cameras and digital cameras capture life's most precious moments in an immediate, convenient, and personal manner. These images can be shared online, but largely remain on the devices that capture them. Beyond photographic images, other forms of humanity's creative expression that capture precious moments include figurines, busts, sculptures, and statues, which also enable memorializing valued experiences myths, heroes, and values. However, adding an individual's resemblance to these forms of creative expression have been mostly relinquished to commissioned work wherein the personal choices are made by artists.

Advances in scanning and 3D printing technology allow for the capture of an individual's resemblance in three-dimensional form, therefore, expanding the introduction of personal resemblance into sculptures, figurines, and various memento designs. Scanning services require an in-person scan done within a scanning both. The individual poses on a turntable and scanners and/or cameras capture the individual's resemblance from head to foot. Scanning booths require in-person scanning, and are thus inconvenient. Furthermore, three-dimensional (3D) computer artist develop the captured resemblance into a 3D model that is ready for 3D printing.

Photo upload services are centered on facial construction and facial analysis technology. Through uploaded photos of numerous views of the face, a three-dimensional form of the head is created and 3D printed. The 3D printed head is then added to standard body offerings, creating a toy version of an individual's resemblance in the form of an action figures, doll, figurines or masks. This application of a 3D printed head with a personal resemblance onto a standard body also limits creative expression.

There exists a need for a convenient mode of creating three-dimensional portraiture that allows for greater creative expression. As stated above, adding an individual's resemblance to forms of creative expression have been mostly relinquished to commissioned work and the personal choices of artists. The current invention solves this problem

### SUMMARY OF THE INVENTION

In one aspect of the present invention, a method for producing a parametric portraiture assembly includes providing a parametric portraiture assembly system; uploading of one or more three-dimensional images to the parametric portraiture assembly system; the parametric portraiture assembly system providing a product customizer feature configured to receive inputted customization information; the parametric portraiture assembly system operatively associated with an additive manufacture device and the supply and generation of organic forms and/or mechanical forms; and additively manufacturing organic forms and mechanical forms to produce the parametric portraiture assembly based in part on the one or more three-dimensional images and embodying the inputted customization information in one or more assembly component of the parametric portraiture assembly.

In another aspect of the present invention, the method for producing a parametric portraiture assembly includes providing a parametric portraiture assembly system; uploading of one or more three-dimensional images to the parametric portraiture assembly system; the parametric portraiture assembly system providing a product customizer feature configured to receive inputted customization information, wherein the inputted customization information includes texture, material, colors, and engraving text; the parametric portraiture assembly system operatively associated with an additive manufacture device and the supply and generation of organic forms and/or mechanical forms; additively manufacturing the organic forms and/or mechanical forms to produce the parametric portraiture assembly based in part on the one or more three-dimensional images and embodying the inputted customization information in one or more assembly component of the parametric portraiture assembly; a distribution platform operatively associated with the parametric portraiture assembly system; and a product viewer wherein a draft model of the parametric portraiture assembly is viewable through a user interface, wherein the product view is configured to apply rotate, zoom, and pan functionality to the viewable draft model.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention;

FIG. 2 is a flowchart of an exemplary embodiment of the present invention; and

FIG. 3 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention is an interactive online platform for the personalization, purchase, and delivery of personalized creative sculptures and designs. The parametric portraiture design and customization system combines CAD solutions, WebGL technology, and 3D artist software to produce creative sculptures and an interactive space for the personalization of these creative portraiture sculptures and designs. The individual resemblance for the creative designs is developed through upload of scans or the upload of photos. The resemblance is then embedded into sculpture designs that can be personalized to capture valued experiences.

The present invention may include at least one computer with a user interface. The computer may include at least one processing unit coupled to a form of memory. The computer includes, but is not limited to, a server, a microprocessor, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The claimed system allows for the interactive customization of the portrait sculpture embedded in a mixture of organic forms and mechanical forms. In one embodiment, the system allows for customization through a product customizer feature adapted to allow for text design embodied in the design, thus allowing personal messaging. For example, the system includes interactive tools for color scheme selection. It can further include a color book assist in matching web experience with actual look and feel of the product.

The system makes design easily adaptable to varying 3D print processes and materials. It facilitates model upload for web presentation. In one embodiment, the system further includes a product viewer where draft models can be viewed. The model can be rotated, zoomed, and panned for proper reviewing of model. In one embodiment, scan files can be used and reused to produce new and creative sculptures and designs. Facial construction files can be used and reused to produce new and creative sculptures and designs.

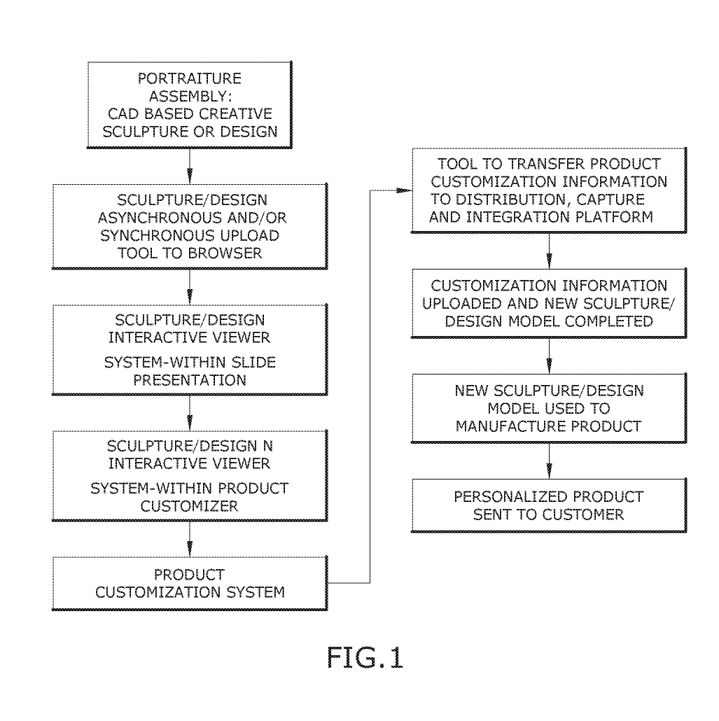

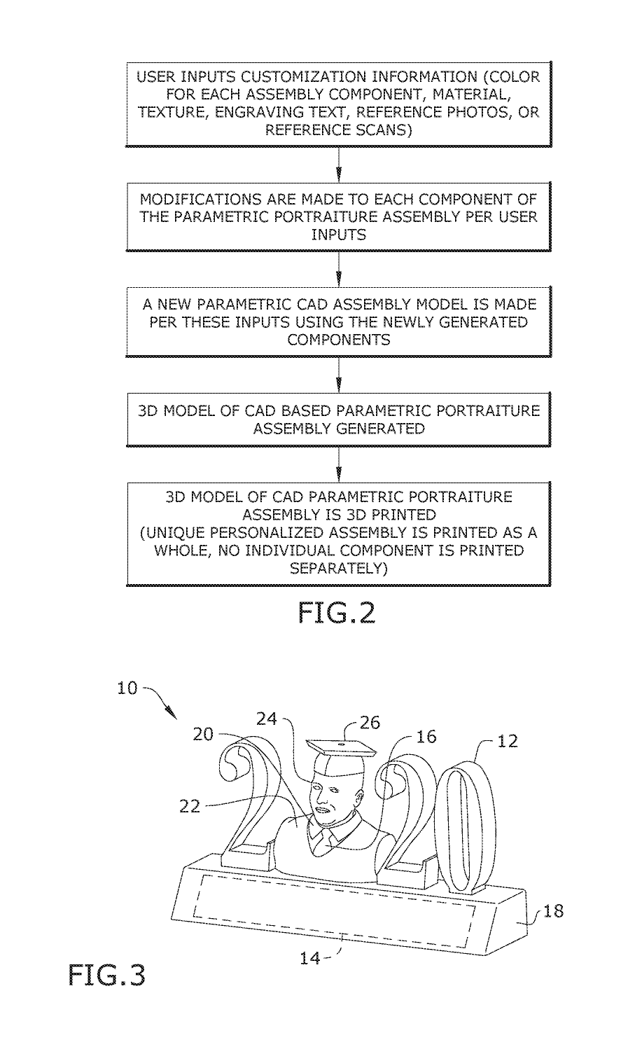

Flowcharts of how the system is used are shown in FIG. 1 and FIG. 2. In one embodiment, components of the online system include:
1) Parametric Portraiture Assembly
2) Customizable Props
3) Customizable Scene
4) Product Customizer
5) Color Picker
6) Color Book for color picker
7) Presentation Product Viewer
8) Product Customizer Product Viewer
9) Distribution Capture/Distribution integration

The present invention is adapted to utilize organic forms and mechanical forms are combined to produce creative sculpture assemblies or creative design assemblies that reflect personal stories. The CAD based parametric sculpture assemblies easily accommodate varying 3D print materials, allowing designs of varying textures and varying design details. The CAD based assembly also allows a facile loading of the design information to a web browser. These assemblies can be explored within various viewers throughout a web-based platform. Product customizers allow users to select varying design elements and apply varying color schemes to the sculptures or designs, therefore tailoring the design details to a specific customer story or graphic identity. The color schemes selection is interactive. Personal messages can also be added to the sculptures reflecting unique experiences. The product customization information is captured through a distribution tool allowing easy purchase of a personalized creative sculpture or design. It is to be understood that various types of product customizers can be added.

A method of using the portraiture assembly may include the following steps: CAD-based creative sculpture or design; sculpture/design asynchronous and/or synchronous upload tool to browser; sculpture/design interactive viewer system within slide presentation and product customizer; product customization system; tool to transfer product customization information to distribution platform; customization information uploaded and new sculpture/design model completed; new sculpture/design model used to manufacture product; and personalized product sent to customer.

Another approach inputs customization information (color for each assembly component, material, texture, engraving text, reference photos, or reference scans; modifications are made to each component of the parametric portraiture assembly per user inputs; a new parametric CAD assembly model is made per these inputs using the newly generated components, 3D models of CAD-based parametric portraiture assembly generated; and 3D model of CAD parametric portraiture assembly is 3D printed enabling a unique personalized assembly printed as a whole, wherein no individual component is printed separately.

One example of a parametric portraiture assembly 10 created by the system is shown in FIG. 3. The assembly 10 shows examples of customized features such as the year 12, an engraving 14, a tie 16, a platform 18, a shirt 29, a gown 22, a head 24, and a cap 26.

In an alternative embodiment, a customer can create any personalized creative sculpture or design that is not limited to portraiture-based designs.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for producing a parametric portraiture assembly, comprising:
providing a parametric portraiture assembly system;
uploading of one or more three-dimensional images to the parametric portraiture assembly system;
the parametric portraiture assembly system providing a product customizer feature configured to receive inputted customization information;
the parametric portraiture assembly system operatively associated with an additive manufacture device and a supply or a generation of organic forms and/or mechanical forms; and
additively manufacturing organic forms and mechanical forms to produce the parametric portraiture assembly based in part on the one or more three-dimensional images and embodying the inputted customization information in one or more assembly component of the parametric portraiture assembly.

2. The method of claim 1, wherein the inputted customization information includes texture and material.

3. The method of claim 1, wherein the inputted customization information includes one or more colors.

4. The method of claim 1, wherein the inputted customization information includes an engraving text.

5. The method of claim 1, wherein the inputted customization information includes a photo or scan.

6. The method of claim 1, wherein the parametric portraiture assembly system is coupled to a distribution platform.

7. The method of claim 1, further comprising a product viewer wherein a draft model of the parametric portraiture assembly is viewable through a user interface.

8. The method of claim 6, wherein the product view is configured to apply rotate, zoom, and pan functionality to the viewable draft model.

9. A method for producing a parametric portraiture assembly, comprising:
providing a parametric portraiture assembly system;
uploading of one or more three-dimensional images to the parametric portraiture assembly system;
the parametric portraiture assembly system providing a product customizer feature configured to receive inputted customization information, wherein the inputted customization information includes texture, material, colors, engraving text, and photos or scans;
the parametric portraiture assembly system operatively associated with an additive manufacture device and a supply or a generation of organic forms and/or mechanical forms;
additively manufacturing the organic forms and/or mechanical forms to produce the parametric portraiture assembly based in part on the one or more three-dimensional images and embodying the inputted customization information in one or more assembly component of the parametric portraiture assembly;
a distribution platform operatively associated with the parametric portraiture assembly system; and
a product viewer wherein a draft model of the parametric portraiture assembly is viewable through a user interface, wherein the product view is configured to apply rotate, zoom, and pan functionality to the viewable draft model.
